(19) United States
(12) Patent Application Publication
(10) Pub. No.: US 2008/0149444 A1
(43) Pub. Date: Jun. 26, 2008

(54) Torsional vibration damper

(75) Inventor: Mario Degler, Baden-Baden (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/998,445

(22) Filed: Nov. 29, 2007

(30) Foreign Application Priority Data
Nov. 29, 2006 (DE) 10 2006 056 296.8

(51) Int. Cl. F16F 15/129; F16D 33/00

(52) U.S. Cl. 192/3.33; 464/68.4

(57) ABSTRACT

A torsional vibration damper for incorporation into the power train of a motor vehicle. The vibration damper includes an input part that is rotatable around an axis of rotation relative to an output part with energy storage elements interposed. At least one holding element is provided on the output part for retaining the energy storage elements on the output part.

### BACKGROUND OF THE INVENTION

1. Field of the Invention

The present invention relates to a torsional vibration damper, particularly for the power train of a motor vehicle. The vibration damper includes an input part that is rotatable relative to an output part about an axis of rotation, with energy storage elements interposed between the input part and the output part.

2. Description of the Related Art

A hydrodynamic power transmitting unit that includes a torsional vibration damper is disclosed in German patent specification DE 42 13 341 C2. That unit includes a housing with a housing wall within which energy storage elements are situated. On the far side of the housing wall from the energy storage devices abutment regions are provided, which are attached to an axial region of a housing plate. The abutment regions are formed by pockets that are stamped onto an annular component.

In German patent specification DE 43 33 562 C2 a power transmitting unit is disclosed having a fluid coupling and a torsional vibration damper with energy storage devices that operate in the circumferential direction. Radially inwardly of the energy storage devices, a disk-shaped element is connected axially and in a rotationally fixed connection to an annular component through spacing means. The annular component forms abutment regions for the energy storage devices in the diameter range of the latter, which are situated corresponding to the abutment regions of the disk-shaped element. The abutment regions in the components can be formed by axial deformations of the components toward each other.

An object of the present invention is to simplify the design and the manufacture of a torsional vibration damper and of a hydrodynamic torque converter that includes a torsional vibration damper.

### SUMMARY OF THE INVENTION

The object is achieved with a torsional vibration damper, in particular one located in the power train of a motor vehicle, having an input part that is rotatable around an axis of rotation relative to an output part, with energy storage elements interposed therebetween, by providing at least one holding element on the output part for holding the energy storage elements. The holding element, in a simple manner, prevents the energy storage elements and/or a slide shell from falling out of the output part. Additional components, such as a carrier plate to fix the energy storage elements and/or a slide shell, can be dispensed with.

A preferred exemplary embodiment of the torsional vibration damper is characterized in that the holding element is attached to the output part. For example, the holding element can be welded, riveted, or crimped to the output part.

Another preferred exemplary embodiment of the torsional vibration damper is characterized in that the holding element is made in one piece with the output part. The output part is preferably a formed sheet metal part.

Another preferred exemplary embodiment of the torsional vibration damper is characterized in that the holding element is formed by a strap that extends radially inwardly from the output part. The holding element can also be formed by a holding lug, a holding wing, or a holding finger.

Another preferred exemplary embodiment of the torsional vibration damper is characterized in that the output part positions the energy storage elements radially outwardly. Preferably, the output part includes at least one receiving channel for an energy storage element. That has the advantage that additional components for positioning the energy storage elements can be dispensed with.

Another preferred exemplary embodiment of the torsional vibration damper is characterized in that between the energy storage elements and the output part a slide shell is situated, which is engaged by the output part and the holding element. According to another essential aspect of the invention, the slide shell is also prevented from falling out by the holding element.

Another preferred exemplary embodiment of the torsional vibration damper is characterized in that the holding element extends essentially in the axial direction before installation of the energy storage elements or the slide shell. In a simple way, that enables utilization of the energy storage elements and of the slide shell, as appropriate.

Another preferred exemplary embodiment of the torsional vibration damper is characterized in that the holding element extends essentially in the radial direction after installation of the energy storage elements or the slide shell. After insertion of the energy storage elements and of the slide shell, as appropriate, the holding element is bent by about 90 degrees.

Another preferred exemplary embodiment of the torsional vibration damper is characterized in that a plurality of holding elements are distributed, especially uniformly, about the periphery of the output part. One or more holding elements can be provided per energy storage element.

In a method for installing a torsional vibration damper described earlier, the object indicated earlier is achieved in that the holding element or holding elements are shaped after the insertion of energy storage elements into the output part, so that the holding element or holding elements at least partially encloses or enclose the energy storage elements. After being shaped, the holding element or holding elements serve to prevent the energy storage elements from falling out of the output part.

A preferred exemplary embodiment of the method is characterized in that the holding element or holding elements are shaped by roller burnishing, bend forming, stamping, crimping, pressing, or tumbling, and in such a way that the holding element or holding elements at least partially encloses or enclose the energy storage elements in the output part. The holding element can also be formed by a circumferential collar, which is partially deformed after the energy storage elements are inserted into the output part.

In a hydrodynamic torque converter having a converter housing that includes a converter cover which is connectable to or connected to a drive unit in a rotationally fixed connection, the problem indicated earlier is solved by situating a previously described torsional vibration damper in the converter housing so that the holding elements face the converter cover. The torsional vibration damper is preferably part of a double damper.

A preferred exemplary embodiment of the hydrodynamic torque converter is characterized in that the torsional vibration damper is connected in series with a torque converter lockup clutch that is situated in a converter housing. The torque converter lockup clutch is preferably constructed as a multi-disk clutch.

Another preferred exemplary embodiment of the hydrodynamic torque converter is characterized in that the torsional vibration damper is situated radially outwardly of and in the axial direction partially overlapping the torque converter lockup clutch. That makes it possible to save construction space.

### BRIEF DESCRIPTION OF THE DRAWINGS

The structure, operation, and advantages of the present invention will become further apparent upon consideration of the following description, taken in conjunction with the accompanying drawings in which:

FIG. 1 is a half-sectional view of an embodiment of a torque transmitting device in accordance with the invention; and

FIG. 2 is a fragmentary axial view of the torque transmitting device of FIG. 1 taken in the direction indicated by the arrow associated with the plane 11 of FIG. 1.

### DESCRIPTION OF THE PREFERRED EMBODIMENTS

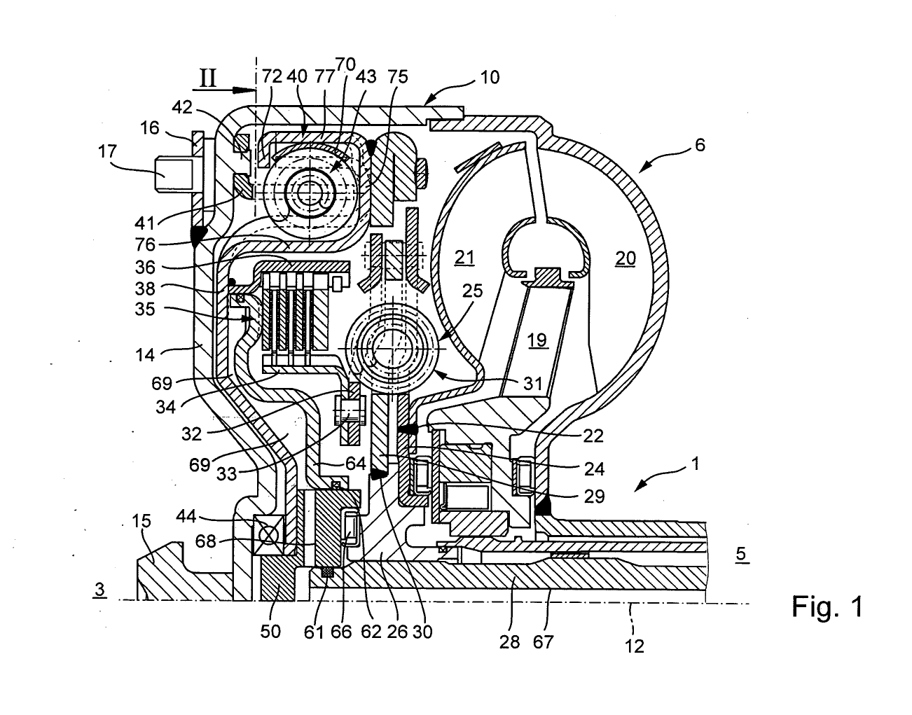

A longitudinal half-section of a power train 1 of a motor vehicle is shown in FIG. 1. Between a drive unit 3, in particular an internal combustion engine, which is indicated only by a reference numeral and from which a crankshaft extends, and a transmission 5, which is also indicated only by a reference numeral, a hydrodynamic torque converter 6 is situated. The crankshaft of the internal combustion engine 3 is connected to a housing 10 of torque converter 6 in a rotationally fixed connection, for example through a sheet metal drive plate, also known as a flex plate. The housing 10 of torque converter 6 is rotatable about an axis of rotation 12 and includes a housing wall 14, which is also called the converter cover, close to the drive unit.

Attached to converter cover 14 is a central pilot bearing pin 15, whose function is to pre-center the hydrodynamic torque converter 6 during installation in a central recess in the crankshaft. Welded radially on the outside of converter cover 14 is a sheet metal connection plate 16, from which extend threaded bolts 17 with which converter cover 14 is attached to a sheet metal drive plate (not shown).

The hydrodynamic torque converter 6 includes a stator 19, an impeller 20, and a turbine 21. Turbine 21 is firmly connected to a side plate 24 by a weld 22. The side plate 24 represents the input part of a torsional vibration damper 25, which is situated in the axial direction between the converter cover 14 and the turbine 21. The torsional vibration damper 25 includes a damper hub 26, on the outer radial surface of which the side plate 24 and the attached turbine 21 are rotatably mounted.

The radially inner surface of damper hub 26 is non-rotatably connected to a transmission input shaft 28. The output part of the torsional vibration damper 25 is formed of a damper flange 29, which is firmly connected to damper hub 26 by a weld 30. Damper flange 29 is coupled with side plate 24 and with another side plate 32 by intermediately positioned springs 31. Side plate 32, which represents another input part of torsional vibration damper 25, is firmly connected by rivet fastening elements 33 to an inner disk carrier 34 of a torque converter lockup clutch 35 having a lamellar construction.

Torque converter lockup clutch 35 also includes an outer disk carrier 36, which is attached to an output part 38 of another torsional vibration damper 40. Torsional vibration damper 40 includes an input part 41, which is attached to converter cover 14 by rivet-like fastening elements 42. The rivet-like fastening elements 42 are formed by projections that extend from converter cover 14. The input part 41 of torsional vibration damper 40 is coupled with the output part 38 by springs 43, which are shown as coil springs. Situated between the output part 38 of torsional vibration damper 40 and converter cover 14 is a roller bearing 44, especially a ball bearing. The output part 38 of torsional vibration damper 40 is rotatably supported relative to converter cover 14 by roller bearing 44. Torsional vibration damper 40 and torsional vibration damper 25 together form a double damper arrangement.

Roller bearing 44 and the output part 38 of torsional vibration damper 40 are supported on a hub 50. A reduced diameter end of transmission input shaft 28 is rotatably received in hub 50 with a sealing effect. To improve the sealing effect, a sealing ring 61 is partially received in an annular groove that is formed in the reduced diameter end of the transmission input shaft. Hub 50 lies against sealing ring 61. Another sealing ring 62 is partially received in an annular groove that is formed on a piston 64 of torque converter lockup clutch 35. Piston 64 is sealingly supported on hub 50 so that it is axially movable, and if necessary rotatable.

A bearing 66 is positioned in the axial direction between hub 50 and damper hub 26. Bearing 66 is preferably an axial bearing, which serves to support axial forces. Alternatively or additionally, however, it can also be a radial bearing. Bearing 66 is designed, for example, as a sliding bearing or as a roller bearing.

Transmission input shaft 28 is provided internally with a central cavity 67 for feeding in or for removing a hydraulic medium. The cavity 67 is connected to a pressure chamber 69 by a flow channel 68, which extends radially through hub 50. Pressure chamber 69 is bounded by the output part 38 of torsional vibration damper 40 and the piston 64 of torque converter lockup clutch 35.

The output part 38 of torsional vibration damper 40 has radially outwardly an essentially U-shaped cross section or receiving channel, with a base 75 from which two legs, an inner leg 76 and an outer leg 77 extend in the axial direction. The base 75 extends radially. The U-shaped cross section bounds on its inside at least one receiving space for receiving the springs 43. Situated between the springs 43 and the outer leg 77 is a slide shell 70.

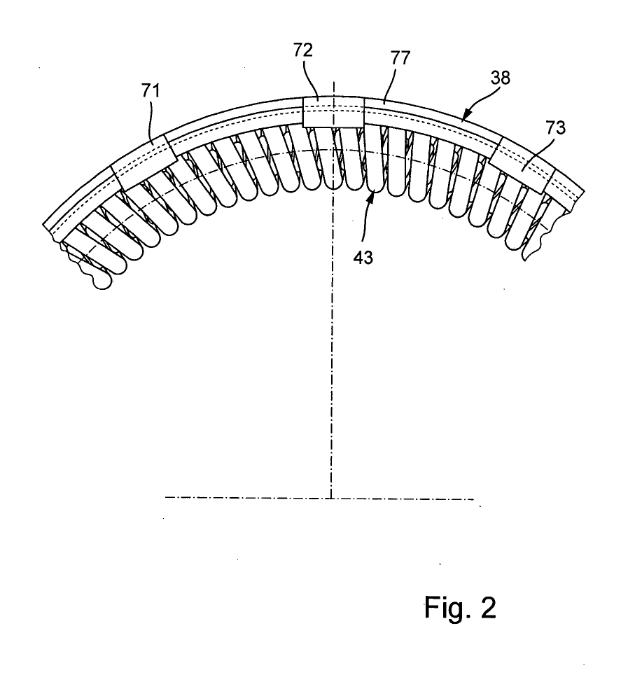

FIG. 2 shows a partial cross-sectional view in the direction of arrow 11 of FIG. 1. In FIG. 2 it can be seen that the holding elements 71, 72, and 73 extend radially inwardly from the outer leg 77 of output part 38 of torsional vibration damper 40. In the half section shown in FIG. 1 it can be seen that holding element 72, just like the other holding elements, prevents the springs 43 and slide shell 70 from falling out at the open side of the U-shaped cross section that faces the converter cover 14. Holding elements 71, 72, and 73 are in the form of holding flaps or tabs that are connected to the outer leg 77 of output part 38 as integral parts thereof.

Holding elements 71, 72, and 73 prevent one or more energy storage elements or springs 43 from being displaced from the U-shaped cross section, as well as preventing slide shell 70 from being displaced out of the receiving channel bounded by the U-shaped cross section. The holding elements can also be in the form of lugs, wings, or finger elements. Before the installation of the slide shell 70 and of the springs 43, holding elements 71, 72, and 73 extend in the axial direction; that is, prior to the installation, holding elements 71, 72, and 73 extend as axial extensions of the outer leg 77 of output part 38. After the springs 43 and slide shell 70 are inserted into the U-shaped cross section of output part 38, holding elements 71, 72, and 73 are bent radially inwardly by one or more shaping processes. Possible shaping processes for bending the holding elements include roller burnishing, bend forming, stamping, coining, crimping, pressing, and tumbling.

In the interior of the receiving channel formed by the U-shaped cross section of output part 38, the springs 43 are preferably surrounded by oil or grease. Stops for the springs 43 are also introduced directly or indirectly into the output part 38 of torsional vibration damper 40. The stops can be introduced directly by a suitable shaping process. The stops can also be introduced indirectly, however, through additional elements such as stop plates, for example. Such stop plates can be welded or riveted onto the output part. The stop plates can also be crimped onto the output part.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A torsional vibration damper for the power train of a motor vehicle, said vibration damper comprising: an input part that is rotatable relative to an output part about an axis of rotation; at least one energy storage element interposed between the input part and the output part; and at least one holding element provided at an outer periphery of the output part for holding the at least one energy storage element relative to the output part.

2. A torsional vibration damper in accordance with claim 1, wherein the at least one holding element is an attachment to the output part.

3. A torsional vibration damper in accordance with claim 1, wherein the at least one holding element is integrally formed with the output part.

4. A torsional vibration damper in accordance with claim 3, wherein the at least one holding element is in the form of a tab that extends radially inwardly from the outer periphery of the output part.

5. A torsional vibration damper in accordance with claim 1, wherein the output part positions the at least one energy storage element radially outwardly of the axis of rotation.

6. A torsional vibration damper in accordance with claim 1, wherein the output part includes at least one receiving channel for receiving the at least one energy storage element.

7. A torsional vibration damper in accordance with claim 1, wherein a slide shell is situated between the at least one energy storage element and a surface of the output part, which slide shell is retained by the output part and the at least one holding element.

8. A torsional vibration damper in accordance with claim 1, wherein the at least one holding element extends substantially in the axial direction prior to installation of the at least one energy storage element.

9. A torsional vibration damper in accordance with claim 8, wherein the at least one holding element extends substantially in a radial direction following installation of the energy storage element or of the slide shell.

10. A torsional vibration damper in accordance with claim 1, wherein a plurality of holding elements are distributed about the outer periphery of the output part.

11. A method for assembling a torsional vibration damper, said method comprising the steps of:
providing a torsional vibration damper output part for receiving at least one energy storage element, wherein the output part is rotatable about an axis of rotation, the output part including at least one holding element for holding the at least one energy storage element and that extends is a substantially axial direction;
installing the at least one energy storage element in a predetermined position adjacent to an outer periphery of the output part; and
shaping the at least one holding element so that the at least one holding element retains the at least one energy storage element relative to the output part.

12. A method in accordance with claim 11, including the step of shaping the at least one holding element by at least one of roller burnishing, bend forming, stamping, crimping, pressing, and tumbling, so that the at least one holding element at least partially encloses and retains the at least one energy storage element relative to the output part.

13. A hydrodynamic torque converter, said converter comprising: a converter housing that includes a converter cover connected in a rotationally fixed connection to a drive unit; a torsional vibration damper situated within the converter housing and including an input part that is rotatable relative to an output part about an axis of rotation, the vibration damper having at least one energy storage element interposed between the input part and the output part, and at least one holding element provided at an outer periphery of the output part for holding the at least one energy storage element relative to the output part; wherein the at least one holding element extends toward and faces the converter cover.

14. A hydrodynamic torque converter in accordance with claim 13, wherein the torsional vibration damper is positioned in series with a torque converter lockup clutch that is positioned within the converter housing.

15. A hydrodynamic torque converter in accordance with claim 14, wherein the torsional vibration damper is positioned radially outwardly of and partially axially overlapping the torque converter lockup clutch.

16. A torsional vibration damper in accordance with claim 1 having a plurality of energy storage elements and a plurality of holding elements.

17. A torsional vibration damper in accordance with claim 1, wherein the at least one energy storage element is a spring.

18. A torsional vibration damper in accordance with claim 10, wherein the holding elements are substantially uniformly spaced along the periphery of the output part.
